(19) United States
(12) Patent Application Publication
(10) Pub. No.: US 2025/0309404 A1
(43) Pub. Date: Oct. 2, 2025

(54) POWER STORAGE DEVICE AND METHOD OF MANUFACTURING POWER STORAGE DEVICE

(71) Applicant: TOYOTA JIDOSHA KABUSHIKI KAISHA, Aichi-ken (JP)

(72) Inventor: Yoshiyuki HAYASHI, Nisshin-shi (JP)

(21) Appl. No.: 19/070,905

(22) Filed: Mar. 5, 2025

(30) Foreign Application Priority Data
Mar. 26, 2024 (JP) 2024-049389

(51) Int. Cl. H01M 10/6556; H01M 10/613; H01M 10/615; H01M 10/6568; H01M 50/136

(52) U.S. Cl. CPC H01M 10/6556; H01M 10/613; H01M 10/615; H01M 10/6568; H01M 50/136

(57) ABSTRACT

A power storage device includes a power storage module and a heat exchanger whose heat exchange object is the power storage module. The power storage module is joined to the heat exchanger with an adhesive. The heat exchanger exchanges heat with the heat exchange object using refrigerant flowing through a main flow path and a sub-flow path. The heat exchanger includes a base member and an outer wall. The outer wall is provided in the base member. The main flow path is formed inside the base member. The sub-flow path is formed of the base member and the outer wall. The outer wall deforms more easily than the base member and the power storage module.

### CROSS REFERENCE TO RELATED APPLICATIONS

This nonprovisional application is based on Japanese Patent Application No. 2024-049389 filed on Mar. 26, 2024, with the Japan Patent Office, the entire contents of which are hereby incorporated by reference.

### BACKGROUND

### Field

The present disclosure relates to a power storage device and a method of manufacturing a power storage device.

### Description of the Background Art

For example, Japanese National Patent Publication No. 2013-545219 discloses a heat exchanger that exchanges heat with a power storage module. The power storage module and the heat exchanger exchange heat in the region where they come into contact with each other.

### SUMMARY

The heat exchanger disclosed in Japanese National Patent Publication No. 2013-545219 includes an outer plate and an inner plate. A flow path is formed in the heat exchanger by the outer plate and the inner plate that has a boss. The boss portion is formed to be compressible by an input supplied to the outer plate from the outside.

With this configuration, when the power storage module is stacked on the heat exchanger, the outer plate deforms due to the deformation of the boss along the surface shape of the power storage module. The deformation of the outer plate increases the region where the outer plate comes into contact with the power storage module. This results in efficient heat exchange.

However, since the outer plate deforms based on the deformation of the boss, the outer plate deforms vertically at the nodes and maintains a planar shape without deforming between the nodes. Thus, the deformation of the outer plate cannot match the fine shape of the heat exchange object. As a result, a gap still occurs between the outer plate and the power storage module. The sectional area of the refrigerant flow path reduces by the area of the resulting gap, reducing the work rate for cooling and temperature increase.

The present disclosure has been made in view of the above problem. An object of the present disclosure is to provide a heat exchanger having a shape that matches the surface shape of a heat exchange object, such as a power storage module.

A power storage device according to a first aspect of the present disclosure includes a power storage module, and a heat exchanger whose heat exchange object is the power storage module. The power storage module is joined to the heat exchanger with an adhesive. The heat exchanger exchanges heat with the heat exchange object using refrigerant flowing through a main flow path and a sub-flow path. The heat exchanger includes a base member and an outer wall. The outer wall is provided in the base member. The main flow path is formed inside the base member. The sub-flow path is formed of the base member and the outer wall. The outer wall deforms more easily than the base member and the power storage module.

The outer wall of the power storage device according to the first aspect of the present disclosure has a coefficient of linear expansion larger than that of the base member.

The outer wall of the power storage device according to the first aspect of the present disclosure has a yield stress smaller than that of the base member.

The outer wall of the power storage device according to the first aspect of the present disclosure has a modulus of elasticity lower than that of the base member.

A method of manufacturing a power storage device according to a second aspect of the present disclosure includes an application step, an arrangement step, and a deformation step. The power storage device includes a power storage module, and a heat exchanger that cools, or increases a temperature of, the power storage module with refrigerant flowing through a main flow path and a sub-flow path. The heat exchanger includes a base member and an outer wall. The outer wall is provided in the base member. The main flow path is formed inside the base member. The sub-flow path is defined by the base member and the outer wall. The outer wall deforms more easily than the base member and the power storage module. The application step includes applying an adhesive to a surface of an outer surface of the outer wall, the surface facing the power storage module. The arrangement step includes alternately stacking the power storage module and the heat exchanger in a first direction. The deformation step includes flowing a fluid through the sub-flow path to deform the outer wall along a shape of the power storage module.

In the method of manufacturing a power storage device according to the second aspect of the present disclosure, the fluid has a temperature of 200° C. or higher.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an exploded perspective view of a power storage device according to the present embodiment.

FIG. 2 is a sectional view taken along the II-II cross-section in FIG. 1.

FIG. 3 is a sectional view of a power storage module according to the present embodiment.

FIG. 4 shows an example application step in a method of manufacturing a power storage device according to the present embodiment.

FIG. 5 shows an example arrangement step in the method of manufacturing a power storage device according to the present embodiment.

FIG. 6 shows an example deformation step in the method of manufacturing a power storage device according to the present embodiment.

### DESCRIPTION OF THE PREFERRED EMBODIMENTS

Embodiments of the present disclosure will be described with reference to the drawings. In the drawings referred to below, the same or corresponding portions in the drawings are denoted by the same reference characters.

### Configuration of the Present Embodiment

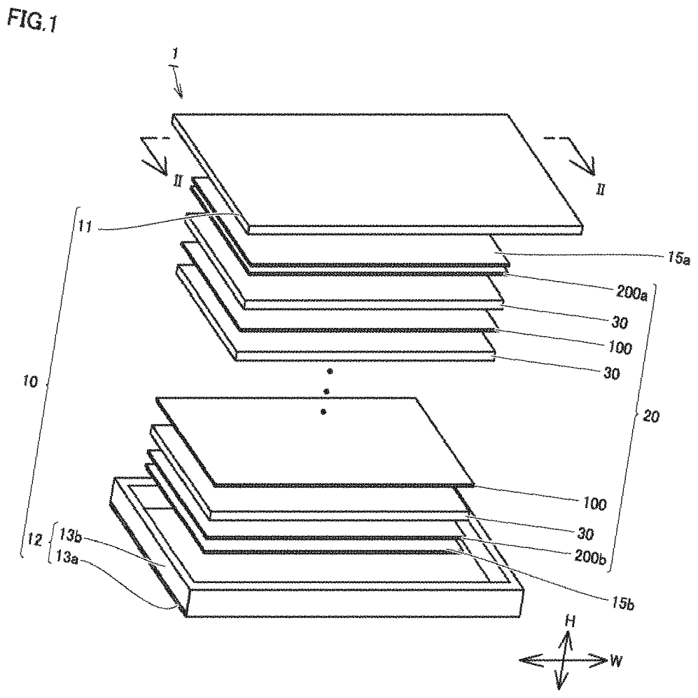

FIG. 1 is an exploded perspective view of a power storage device according to the present embodiment. In FIG. 1, a stacking direction H indicates the stacking direction of a stack 20, which will be described later. A width direction W indicates the width direction of a power storage device 1. Herein, stacking direction H is an example of the “first direction” of the present disclosure.

Power storage device 1 includes an accommodation case 10 and stack 20. Accommodation case 10 accommodates stack 20 therein and restrains stack 20 in stacking direction H.

Accommodation case 10 includes an upper cover 11 and a lower case 12. Upper cover 11 and lower case 12 are arranged while being spaced apart from each other in stacking direction H. Upper cover 11 and lower case 12 are restrained in stacking direction H with bolts or the like.

Lower case 12 is formed to be open upward. Lower case 12 has a lower plate 13a and a peripheral wall 13b. Lower plate 13a is formed in a rectangular shape as lower plate 13a is viewed in plan from a position distant from lower plate 13a in stacking direction H. Peripheral wall 13b is formed so as to rise from the outer peripheral edge of lower plate 13a. Upper cover 11 is formed so as to cover the opening of lower case 12.

Stack 20 is accommodated in accommodation case 10. Insulating films 15a, 15b having electrical insulation properties are arranged between accommodation case 10 and stack 20. Consequently, accommodation case 10 is insulated from stack 20.

Stack 20 includes a plurality of power storage modules 30, a main heat exchanger 100, a terminal heat exchanger 200a, and a terminal heat exchanger 200b. Power storage modules 30 are stacked in stacking direction H with main heat exchanger 100 in between. In stacking direction H, terminal heat exchanger 200a is arranged at one end of stacked power storage modules 30. Terminal heat exchanger 200b is arranged at the other end of power storage modules 30. Power storage module 30 is an example of the “heat exchange object” of the present disclosure. Main heat exchanger 100 and terminal heat exchangers 200a, 200b are examples of the “heat exchanger” of the present disclosure.

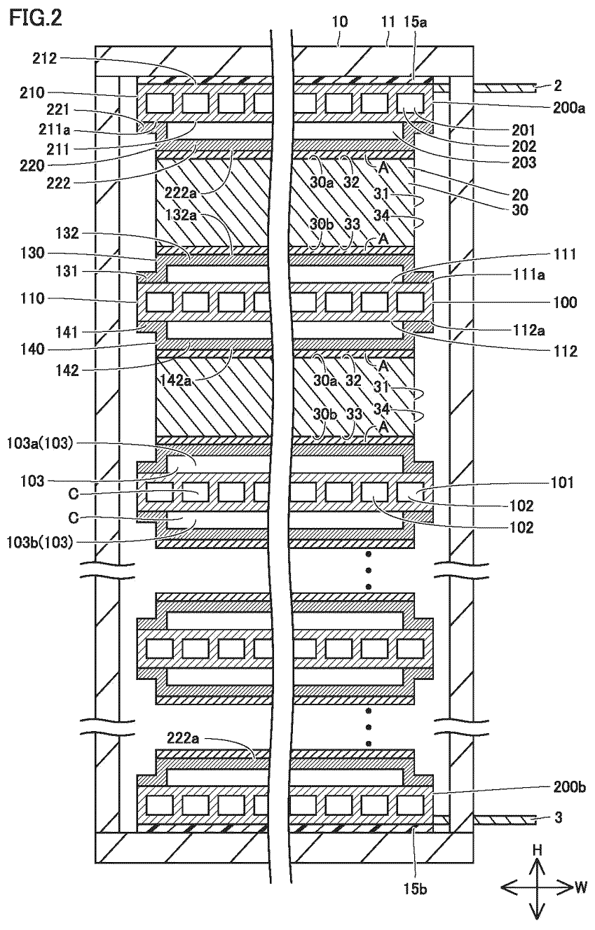

FIG. 2 is a sectional view taken along the II-II cross-section in FIG. 1. Power storage module 30 is, for example, a bipolar battery. As power storage module 30 is viewed in plan view from a position distant from power storage module 30 in stacking direction H, power storage module 30 is formed in a rectangular shape. Power storage module 30 has main surfaces 30a, 30b arranged in stacking direction H. Power storage module 30 faces main heat exchanger 100 or terminal heat exchanger 200a on a main surface 30a, and power storage module 30 faces main heat exchanger 100 or terminal heat exchanger 200b on a main surface 30b.

An electrically conductive adhesive A is provided between power storage module 30 and main heat exchanger 100, between power storage module 30 and terminal heat exchanger 200a, and between power storage module 30 and terminal heat exchanger 200b. Adhesive A is not an essential component, and adhesive A may not be provided. When adhesive A is not provided, power storage module 30 is in contact with main heat exchanger 100 or terminal heat exchangers 200a, 200b.

Main heat exchanger 100 is electrically conductive. Main heat exchanger 100 electrically connects power storage modules 30 adjacent to main heat exchanger 100.

Main heat exchanger 100 has a flow path therein. Main heat exchanger 100 cools, or increases the temperature of, power storage module 30 adjacent to main heat exchanger 100 using refrigerant C flowing through flow path 101. Flow path 101 has a main flow path 102 and a sub-flow path 103. Sub-flow path 103 has a first path 103a and a second path 103b. The structure of main heat exchanger 100 will be described below in detail.

Main heat exchanger 100 has a base member 110, an outer wall 130, and an outer wall 140.

Main flow path 102 is formed in base member 110. Main flow path 102 is formed of a plurality of flow paths. Base member 110 has a first plane 111 and a second plane 112. First plane 111 and second plane 112 are respectively end faces of base member 110 in stacking direction H. As first plane 111 and second plane 112 are viewed in plan view from a position distant from first plane 111 and second plane 112 in stacking direction H, first plane 111 and second plane 112 are formed in a square shape. First plane 111 includes an outer edge 111a, and second plane 112 includes an outer edge 112a.

Outer wall 130 is provided on first plane 111 of base member 110 in stacking direction H. Outer wall 130 has a plate-shaped member 132 and a joint member 131 formed at the outer peripheral edge of plate-shaped member 132 and formed annularly.

Joint member 131 is formed to extend annularly along outer edge 111a, which is located on first plane 111 and at the end of first plane 111 in width direction W. Joint member 131 is joined to base member 110 by welding, brazing, or the like.

Plate-shaped member 132 is spaced apart from first plane 111 in stacking direction H. Plate-shaped member 132 is formed in the shape that matches main surface 30b of power storage module 30. More specifically, plate-shaped member 132 is formed in the shape that matches the unevenness of main surface 30b in stacking direction H. Plate-shaped member 132 has a main surface 132a. Main surface 132a is a surface that faces main surface 30b of power storage module 30. Adhesive A may be applied to main surface 132a. Adhesive A is arranged to fill the gap between main surface 30b and main surface 132a.

Outer wall 140 is provided on second plane 112 of base member 110 in stacking direction H. Outer wall 140 has a plate-shaped member 142 and a joint member 141 formed at the outer peripheral edge of plate-shaped member 142 and formed annularly.

Joint member 141 is formed to extend annularly along outer edge 112a, which is located on second plane 112 and at the end of second plane 112 in width direction W. Joint member 141 is joined to base member 110 by welding, brazing, or the like.

Plate-shaped member 142 is spaced apart from second plane 112 in stacking direction H. Plate-shaped member 142 is formed in the shape that matches main surface 30a of power storage module 30. More specifically, plate-shaped member 142 is formed in the shape that matches the unevenness of main surface 30a in stacking direction H. Plate-shaped member 142 has a main surface 142a. Main surface 142a is a surface that faces main surface 30a of power storage module 30. Adhesive A may be applied to main surface 142a. Adhesive A is arranged to fill the gap between main surface 30a and main surface 142a.

Terminal heat exchanger 200a and terminal heat exchanger 200b have a configuration similar to that of main heat exchanger 100. Terminal heat exchanger 200a and terminal heat exchanger 200b have a base member and one outer wall. In other words, main heat exchanger 100 includes two outer walls, that is, outer wall 130 and outer wall 140, whereas terminal heat exchanger 200a and terminal heat exchanger 200b include one outer wall. Except for this point, the configurations of terminal heat exchanger 200a and terminal heat exchanger 200b are substantially the same as the configuration of main heat exchanger 100.

Terminal heat exchanger 200a and terminal heat exchanger 200b are electrically conductive. Since terminal heat exchanger 200b has substantially the same configuration as that of terminal heat exchanger 200a, the configuration of terminal heat exchanger 200a will be mainly described below.

Terminal heat exchanger 200a has a base member 210 and an outer wall 220.

A main flow path 202 is formed in base member 210. Main flow path 202 is formed of a plurality of flow paths. Base member 210 has a first plane 211 and a second plane 212. First plane 211 and second plane 212 are respectively end faces of base member 110 in stacking direction H.

As first plane 211 and second plane 212 are viewed in plan view from a position distant from first plane 211 and second plane 212 in stacking direction H, first plane 211 and second plane 212 are formed in a square shape. First plane 211 includes an outer edge 211a, and second plane 212 includes an outer edge 212a.

Outer wall 220 is provided on first plane 211 of base member 210 in stacking direction H. Outer wall 220 has a plate-shaped member 222 and a joint member 221 formed at the outer peripheral edge of plate-shaped member 222 and formed annularly.

Joint member 221 is formed to extend annularly along outer edge 211a, which is located on first plane 211 and at the end of first plane 211 in width direction W. Joint member 221 is joined to base member 210 by welding, brazing, or the like.

Plate-shaped member 222 is spaced apart from first plane 211 in stacking direction H. Plate-shaped member 222 is formed in the shape that matches main surface 30a of power storage module 30. More specifically, plate-shaped member 222 is formed in the shape that matches the unevenness of main surface 30a in stacking direction H. Plate-shaped member 222 has a main surface 222a. Main surface 222a is a surface that faces main surface 30a of power storage module 30. Adhesive A may be applied to main surface 222a. Adhesive A is arranged to fill the gap between main surface 30b and main surface 222a.

Terminal heat exchanger 200a is arranged at one end of stacked power storage modules 30 in stacking direction H. Second plane 212 is adjacent to insulating film 15a. Terminal heat exchanger 200a is connected with a positive electrode terminal 2.

Terminal heat exchanger 200b is arranged at the other end of stacked power storage modules 30 in stacking direction H. Second plane 212 is adjacent to insulating film 15b. Terminal heat exchanger 200b is connected with a negative electrode terminal 3.

Positive electrode terminal 2 and negative electrode terminal 3 each extend in width direction W. Connecting positive electrode terminal 2 and negative electrode terminal 3 to an external terminal enables charging and discharging of power storage device 1.

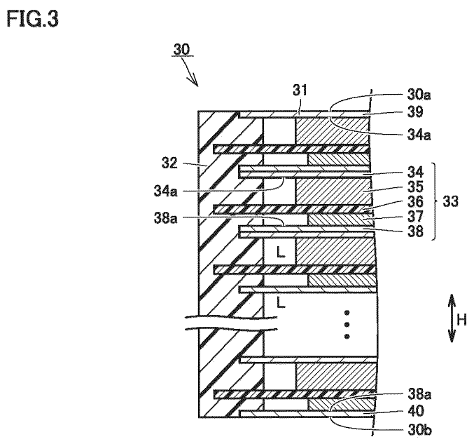

FIG. 3 is a sectional view of the power storage module according to the present embodiment. Power storage module 30 is formed of an electrode stack 31 and a resin portion 32. Electrode stack 31 has a plurality of unit cells 33. Unit cells 33 are stacked in stacking direction H.

Each unit cell 33 has a first current collector plate 34, a first active material layer 35, a separator 36, a second active material layer 37, and a second current collector plate 38.

First current collector plate 34 is made of, for example, aluminum. First active material layer 35 is, for example, a positive electrode active material layer. First active material layer 35 is formed on a first application surface 34a of first current collector plate 34. First application surface 34a is the lower surface of first current collector plate 34.

Second active material layer 37 is, for example, a negative electrode active material layer. Second active material layer 37 is formed on a second application surface 38a of second current collector plate 38. Second application surface 38a is the upper surface of second current collector plate 38. Second current collector plate 38 is made of, for example, copper.

Separator 36 is arranged between first active material layer 35 and second active material layer 37. Separator 36 is formed in, for example, a sheet shape. Separator 36 includes, for example, a polymer that absorbs and retains an electrolyte. Examples of the material of separator 36 include polypropylene (PP), polyethylene (PE), polyolefin, and polyester.

In unit cells 33 adjacent to each other in stacking direction H, first current collector plate 34 of one unit cell 33 is in contact with second current collector plate 38 of the other unit cell. Electrode stack 31 is formed of first current collector plate 34 and second current collector plate 38 in contact.

The space formed by current collector plates 34, 38 and resin portion 32 is sealed with an electrolyte L.

In stacking direction H, first current collector plate 34 is exposed at one end of electrode stack 31, and second current collector plate 38 is exposed at the other end of electrode stack 31. In stacking direction H, first current collector plate 34 and second current collector plate 38, which are exposed at the ends of electrode stack 31, are referred to as end wall 39 and end wall 40, respectively.

End wall 39 has main surface 30a. Main surface 30a is arranged on the other surface of first application surface 34a in stacking direction H. End wall 40 has main surface 30b. Main surface 30b is arranged on the other surface of second application surface 38a in stacking direction H.

Resin portion 32 is formed annularly to surround electrode stack 31. The outer peripheral edge of first current collector plate 34, the outer peripheral edge of second current collector plate 38, and the outer peripheral edge of separator 36 are embedded in resin portion 32.

The constituent material of main heat exchanger 100 is substantially the same as the constituent material of terminal heat exchangers 200a, 200b. Thus, the constituent material of main heat exchanger 100 will be mainly described by comparing the characteristics of the material of outer walls 130, 140 with the material of base member 110.

The material of outer walls 130, 140 of main heat exchanger 100 is larger in coefficient of linear expansion [1/K] than the material of base member 110. The method of measuring the coefficient of linear expansion is based on JIS Z 2285. In other words, the coefficient of linear expansion is calculated based on the relationship between changes in temperature of the sample and the amount of change in length of each sample.

The material of outer walls 130, 140 may be smaller in yield stress [MPa] than the material of base member 110. The method of measuring the yield stress is based on JIS Z 2241. In other words, the yield stress is calculated based on the relationship between the test force at the yield point and the sectional area of the sample.

The material of outer walls 130, 140 may be lower in Young's modulus [N/mm²] than the material of base member 110. The method of measuring the Young's modulus is based on JIS Z 2280. In other words, the Young's modulus is calculated based on the relationship between stress and strain in the elastic range of the sample.

Outer walls 130, 140 may be lower in bending rigidity [N·mm²] than base member 110. The bending rigidity is a value determined from the Young's modulus [N/mm²] and the second moment of area [mm⁴] of outer walls 130, 140.

The configuration described above is also provided in the relationship between base member 210 and outer wall 220 in terminal heat exchangers 200a, 200b, similarly to the relationship between base member 110 and outer walls 130, 140 in main heat exchanger 100.

For example, when stainless steel such as SUS304 or a steel sheet such as SGCC is used for base members 110, 210, aluminum such as A5052-O, 5083-O, or 6063-T5, which has a larger coefficient of linear expansion and a smaller yield stress than those of the stainless steel or steel sheet, can be used for outer walls 130, 140. Alternatively, when aluminum is used for base members 110, 210, a resin material, which has a larger coefficient of linear expansion and a smaller yield stress than those of aluminum, can be used for outer walls 130, 140.

In the embodiment described above, main heat exchanger 100 and terminal heat exchangers 200a, 200b exchange heat with power storage module 30. For example, power storage device 1 mounted in the vehicle cools, or increases the temperature of, power storage module 30 by flowing refrigerant C through flow path 101 of main heat exchanger 100.

In the embodiment described above, for example, plate-shaped member 132 is formed in the shape that matches the unevenness of main surface 30b in stacking direction H.

With this configuration, the area of contact between power storage module 30 and plate-shaped member 132 can be increased more than when there is a gap between power storage module 30 and plate-shaped member 132. Consequently, power storage device 1 including a highly efficient heat exchanger can be provided.

Main heat exchanger 100 or the like of power storage device 1 mounted in a vehicle needs to have a sufficient strength so as not to deform due to an external force. In the embodiment described above, for example, base member 110 is formed of a material that deforms less easily than outer walls 130, 140. Base member 110 has the function of preventing deformation of main heat exchanger 100 particularly due to an external force from width direction W.

With this configuration, the bending rigidity of outer walls 130, 140 can be reduced. In other words, thin plate-shaped members 132, 142 can be used. As a result, the heat capacity of plate-shaped members 132, 142 is reduced, and the length of the heat transfer path from refrigerant C to power storage module 30 is reduced, and accordingly, power storage device 1 capable of control with excellent thermal response can be provided.

In addition, with this configuration, when an external load is applied to main heat exchanger 100, base member 110 can become the main part to suppress deformation of main heat exchanger 100. Also, when the yield stress of the material of base member 110 is larger than that of outer walls 130, 140, or when the Young's modulus of the material of base member 110 is higher than that of outer walls 130, 140, main heat exchanger 100 can have a smaller size and a smaller thickness.

In the power storage device manufactured as described above, for example, the thickness of adhesive A between main surface 30b and plate-shaped member 142 can be made smaller and uniform. As a result, for example, when refrigerant C is supplied to main heat exchanger 100 with the manufactured power storage device 1 mounted in a vehicle or the like, the efficiency of heat exchange of main heat exchanger 100 can be improved more than when the thickness of adhesive A is larger and non-uniform, and power storage module 30 can be cooled, or the temperature of power storage module 30 can be increased, evenly by main heat exchanger 100.

In the power storage device manufactured as described above, for example, plate-shaped member 132 is deformed along the shape of main surface 30b. Thus, compared to a power storage device in which there is a gap between plate-shaped member 132 and main surface 30b because plate-shaped member 132 does not match the shape of main surface 30b, power storage device 1 according to the present embodiment can reduce the amount of adhesive A used, and at the same time, a power storage device can be provided that is smaller in the thickness of adhesive A and is capable of high-efficiency heat exchange. In addition, the sectional area of the flow path for refrigerant C can be made larger in power storage device 1 according to the present embodiment. As a result, when refrigerant C is supplied to main heat exchanger 100 with power storage device 1 mounted in a vehicle, the pressure loss when refrigerant C circulates through flow path 101 can be reduced, and the work rate of the vehicle can be improved.

### Manufacturing Method of the Present Embodiment

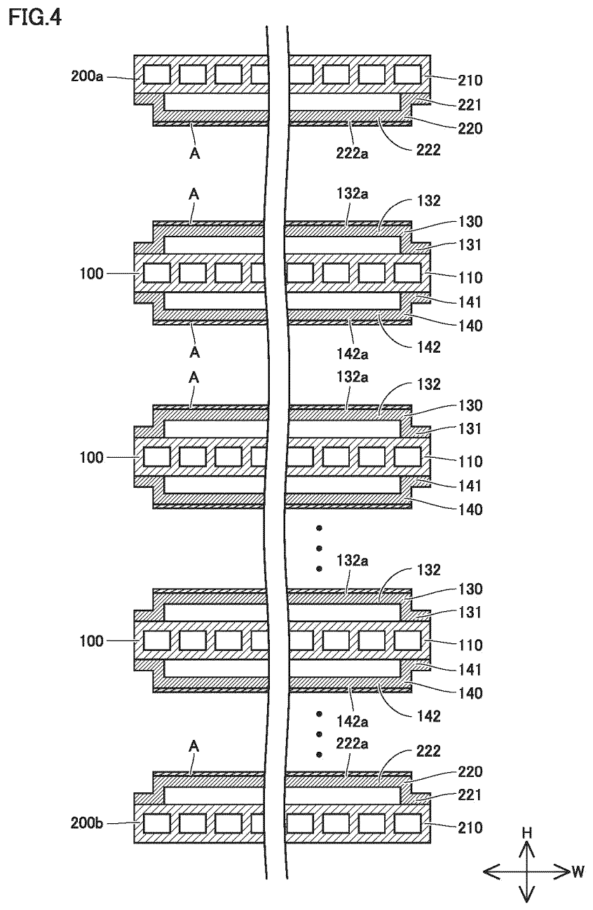

Next, an example of the method of manufacturing power storage device 1 will be described. Power storage device 1 includes an application step, an arrangement step, and a deformation step, in order of steps. The details of the steps will be described below with reference to FIGS. 4 to 6.

FIG. 4 shows an example of the application step. In the application step, adhesive A is applied to main heat exchanger 100, terminal heat exchanger 200a, and terminal heat exchanger 200b. More specifically, adhesive A is applied to main surfaces 132a, 142a of plate-shaped members 132, 142 of main heat exchanger 100. In addition, adhesive A is applied to main surfaces 222a of plate-shaped members 222 of terminal heat exchangers 200a, 200b.

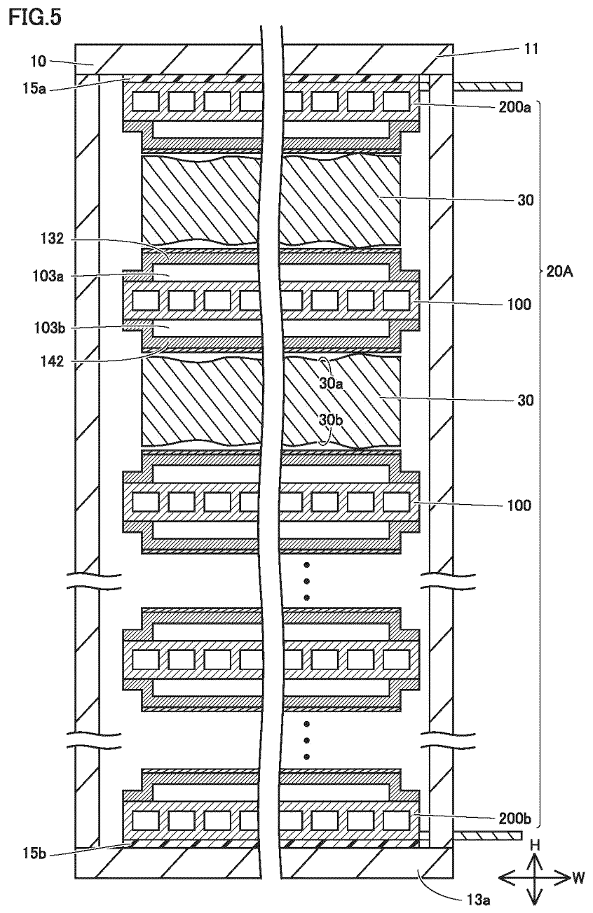

FIG. 5 shows an example of the arrangement step. In the arrangement step, a stack 20A is formed. Specifically, power storage modules 30 are stacked in stacking direction H. Main heat exchanger 100 is arranged between power storage modules 30. Terminal heat exchanger 200a is arranged at one end of stacked power storage modules 30 in stacking direction H. Terminal heat exchanger 200b is arranged at the other end of stacked power storage modules 30 in stacking direction H.

Subsequently, stack 20A is accommodated in accommodation case 10. Insulating films 15a, 15b are arranged between stack 20A and accommodation case 10. Stack 20A is restrained in stacking direction H by upper cover 11 and lower plate 13a that form accommodation case 10.

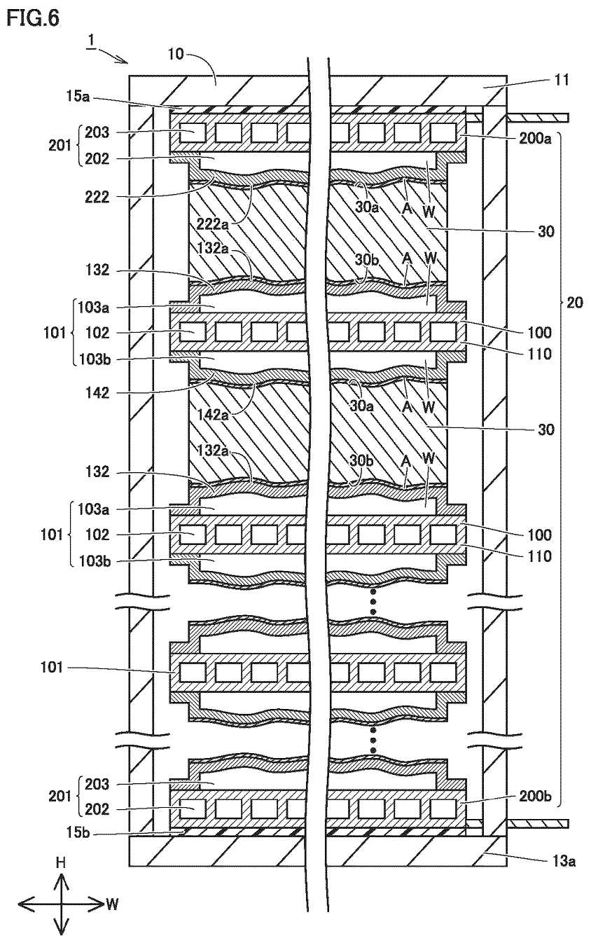

FIG. 6 shows an example of the deformation step. In the deformation step, plate-shaped member 132 is deformed to a shape that matches main surface 30b of power storage module 30. Plate-shaped member 142 is also deformed to a shape that matches main surface 30a of power storage module 30. The same is true for terminal heat exchangers 200a, 200b.

More specifically, a high-pressure fluid W is flowed through first path 103a of main heat exchanger 100. This causes the pressure within first path 103a to become higher than the atmospheric pressure. Since stack 20A is restrained by accommodation case 10 in stacking direction H, plate-shaped member 132 deforms along the shape of main surface 30b by fluid W. Similarly, by flowing high-pressure fluid W through second path 103b of main heat exchanger 100, plate-shaped member 142 is deformed along the shape of main surface 30a. When high-pressure fluid W is flowed through sub-flow path 103 that has first path 103a and second path 103b, preferably, fluid W is also simultaneously flowed through main flow path 102. This is for preventing application of a load to main flow path 102 due to the pressure difference.

The same is true for the deformation of plate-shaped member 222 in terminal heat exchangers 200a, 200b.

In the deformation step, a plurality of heat exchangers may be shaped simultaneously, or heat exchangers may be shaped in order. For example, this step may also serve as a leakage test on the heat exchanger of power storage device 1.

In the embodiment described above, main heat exchanger 100 is arranged at a position adjacent to power storage module 30. For example, plate-shaped member 132 of main heat exchanger 100 deforms more easily than base member 110. Herein, plate-shaped member 132 deforming more easily than base member 110 means formability based on the comparison of coefficient of linear expansion, yield stress, Young's modulus, or second moment of area.

In addition, plate-shaped members 132, 142 of main heat exchanger 100 deform more easily than power storage module 30. Herein, plate-shaped members 132, 142 deforming more easily than power storage module 30 means that even when a load is applied to power storage module 30 from plate-shaped members 132, 142 by flowing a high-pressure fluid W through first path 103a and second path 103b of stack 20A, plate-shaped members 132, 134 deform along main surfaces 30a, 30b without power storage module 30 being damaged.

Power storage module 30 being damaged refers to occurrence of cracks or damage to first active material layer 35, separator 36, or second active material layer 37, buckling of resin portion 32, or leakage of the electrolyte contained in power storage module 30.

In this configuration, as high-pressure fluid W flows through sub-channel 103, plate-shaped members 132, 142 can be deformed to the shape that matches main surfaces 30a, 30b without power storage module 30 being damaged.

High-pressure fluid W is a fluid having a water pressure greater than the output of an in-vehicle pump (5 MPa) and less than 20 MPa. Fluid W is also insulating.

In addition, fluid W may also have high temperature. By flowing high-temperature fluid W through flow path 101, thermal expansion occurs, and plate-shaped member 132 can be deformed along the shape of main surface 30b. In addition, plate-shaped member 132, which is formed of metal, has excellent ductility at high temperatures. Thus, compared to the deformation step using a low-temperature fluid W, the risk of brittle fracture in the deformation step using a high-temperature fluid W can be suppressed.

Herein, high-temperature fluid W means, for example, a fluid of 100° C. or higher and 310° C. or lower. This is because the maximum temperature of refrigerant C when power storage device 1 mounted in the vehicle cools power storage module 30 is 100° C. In particular, when aluminum such as A5052-O, 5083-O, or 6063-T5 is used for outer walls 130, 140, it is desirable that high-temperature fluid W be oil having a temperature of 200° C. or higher.

In addition, the joint portions between base member 110 and outer walls 130, 140 are sufficiently joined without peeling off when outer walls 130, 140 deform.

In the embodiment described above, adhesive A is applied to plate-shaped members 132, 142.

For example, in a power storage device in which the flatness of main surface 30b of power storage module 30 cannot match the flatness of main surface 132a of main heat exchanger 100, a gap occurs between the main surfaces. In order to seal the gap, application of a large amount of adhesive A has been necessary. According to the embodiment of the present disclosure, the amount of adhesive A used can be reduced because plate-shaped member 132 deforms along main surface 30b. As a result, the electrical resistance caused by adhesive A can be reduced by reducing the amount used. In addition, an increase in the size of power storage device 1 can be reduced.

If there is no adhesive A, a gap may occur due to springback after the load due to fluid W is removed, or due to shrinkage after plate-shaped member 132 returns to room temperature. When adhesive A is applied, the shape of plate-shaped member 132 can be maintained even after the load due to fluid W is removed or plate-shaped member 132 returns to room temperature, by curing adhesive A with plate-shaped member 132 deforming along main surface 30b.

Although the present embodiments of the present disclosure have been described, it should be understood that the present embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power storage device comprising:
a power storage module; and
a heat exchanger whose heat exchange object is the power storage module, wherein
the power storage module is joined to the heat exchanger with an adhesive,
the heat exchanger exchanges heat with the heat exchange object using refrigerant flowing through a main flow path and a sub-flow path,
the heat exchanger includes a base member and an outer wall,
the outer wall is provided in the base member,
the main flow path is formed inside the base member,
the sub-flow path is formed of the base member and the outer wall, and
the outer wall deforms more easily than the base member and the power storage module.

2. The power storage device according to claim 1, wherein the outer wall has a coefficient of linear expansion larger than that of the base member.

3. The power storage device according to claim 1, wherein the outer wall has a yield stress smaller than that of the base member.

4. The power storage device according to claim 1, wherein the outer wall has a modulus of elasticity lower than that of the base member.

5. A method of manufacturing a power storage device, the method comprising:
an application step;
an arrangement step; and
a deformation step, wherein
the power storage device includes
a power storage module, and
a heat exchanger that cools, or increases a temperature of, the power storage module with refrigerant flowing through a main flow path and a sub-flow path,
the heat exchanger includes a base member and an outer wall,
the outer wall is provided in the base member,
the main flow path is formed inside the base member,
the sub-flow path is defined by the base member and the outer wall,
the outer wall deforms more easily than the base member and the power storage module,
the application step includes applying an adhesive to a surface of an outer surface of the outer wall, the surface facing the power storage module,
the arrangement step includes alternately stacking the power storage module and the heat exchanger in a first direction, and
the deformation step includes flowing a fluid through the sub-flow path to deform the outer wall along a shape of the power storage module.

6. The method of manufacturing a power storage device according to claim 5, wherein the fluid W has a temperature of 200° C. or higher.
